(19) United States
(12) Patent Application Publication
(10) Pub. No.: US 2011/0310417 A1
(43) Pub. Date: Dec. 22, 2011

(54) PRINTING EVALUATION INFORMATION DISPLAYING APPARATUS AND PRINTING EVALUATION INFORMATION DISPLAYING METHOD FOR PRINTING PRESS

(75) Inventors: Shuichi Takemoto, Hiroshima (JP); Ikuo Ozaki, Hiroshima (JP); Norifumi Tasaka, Hiroshima (JP)

(73) Assignee: MITSUBISHI HEAVY INDUSTRIES, LTD., Tokyo (JP)

(21) Appl. No.: 12/376,298

(22) PCT Filed: Aug. 28, 2007
(86) PCT No.: PCT/JP2007/066667

§ 371 Date: Mar. 23, 2009

(30) Foreign Application Priority Data
Aug. 31, 2006 (JP) 2006-236544

(51) Int. Cl. G06K 15/02

(52) U.S. Cl. 358/1.13

(57) ABSTRACT

It is an object of the invention to provide a printing evaluation information displaying apparatus and method for a printing press wherein the printing operator can grasp printing evaluation information and printing press operation information to be used as parameters of quality management at the same time. The printing evaluation information displaying apparatus for a printing press 100 which includes a sensor 4 for measuring printing paper for which printing is performed by the printing press 100, a printing evaluation information calculation section 31 for calculating one or more kinds of printing evaluation information used as a parameter for quality management of printing paper based on a result of the measurement by the sensor 4, and a display apparatus 22 for displaying the printing evaluation information calculated by the printing evaluation information calculation section 31 includes a printing press operation information acquisition section 32 for acquiring one or more kinds of operation information of the printing press 100, and the display apparatus 22 displaying the printing press operation information together with the printing evaluation information.

### TECHNICAL FIELD

The present invention relates to a printing evaluation information displaying apparatus and a printing evaluation information displaying method for displaying printing evaluation information to be used as a parameter for quality management of printing paper when printing is carried out by a printing press.

### BACKGROUND ART

Conventionally, in order to manage the printing color tone when printing is carried out by a printing press, calculation of various kinds of information (hereinafter referred to as printing evaluation information) to be used as parameters for quality management (color tone management) of printing paper such as dot gain information, trapping information, a solid density, contrast information and so forth is carried out from a result of measurement obtained by measuring reflection light of printing paper, for which printing has been carried out, by means of a reflection light sensor such as an IRGB densitometer.

The printing operator carries out adjustment of the driving state of a printing press (for example, adjustment of the supplying amount of ink or the like) so that the various kinds of printing evaluation information fall within a predetermined suitable region to obtain printing paper having higher quality.

For example, in Patent Document 1, a technique is proposed wherein a sensor for reading printing image information of a printed matter in a state wherein the information is separated into information of three primary colors is disposed on a printing press and the information obtained by the sensor is converted into values such as a printing halftone dot gain value, a trapping value, a gray balance value and so forth and then the converted values and reference values for the values are displayed on the real-time basis.

Since, with the technique disclosed in Patent Document 1, the printing operator can carry out confirmation of the quality of printing paper in a printed state on the real-time basis, color tone adjustment of the printing paper can be carried out rapidly and printing paper having high quality can be obtained.

Patent Document 1: Japanese Patent Laid-Open No. 2005-349739

### DISCLOSURE OF THE INVENTION

### Subject to be Solved by the Invention

Incidentally, the various kinds of printing evaluation information described above greatly relate to the operation state of each apparatus of the printing press such as the supplying amount of ink to be supplied to a plate of a printing drum from an ink supplying apparatus of a printing press, the supplying amount of dampening water to be supplied to the plate of the printing drum from a dampening water supplying apparatus or the operation speed of the printing press or the like, and, when the printing operator carries out color tone adjustment of printing paper, it is necessary to suitably adjust various operation conditions of the printing press so that the printing evaluation information may fall within an appropriate range.

However, in the technique disclosed in Patent Document 1, while various kinds of printing evaluation information are displayed on the real-time basis information regarding operation conditions of the individual apparatus of the printing press (such information is hereinafter referred to as printing press operation information) is not displayed.

Therefore, the printing operator cannot grasp the printing evaluation information and the printing press operation information at the same time, and when color tone adjustment of printing paper is to be carried out based on the printing evaluation information, the printing operator separately confirms the printing press operation information. Therefore, there is a subject that color tone adjustment working of printing paper is delayed and a product whose printing quality is low or printing paper which becomes loss paper as a defect increases or a like subject. Also there is a subject that, where the printing operator carries out color tone adjustment working without separately confirming the printing press operation information, the accuracy of the color tone adjustment working drops, resulting in decrease of the printing quality or increase of loss paper.

The present invention has been made in view of such a situation as described above, and it is an object of the present invention to provide a printing evaluation information displaying apparatus and a printing evaluation information displaying method for a printing press wherein the printing operator can grasp printing evaluation information and printing press operation information to be used as parameters for quality management of printing paper at the same time.

### Means for Solving the Subject

In order to attain the subject described above, according to the invention as set forth in claim 1, there is provided a printing evaluation information displaying apparatus for a printing press, comprising a sensor for measuring printing paper printed by the printing press, a printing evaluation information calculation section adapted to calculate one or more kinds of printing evaluation information each to be used as a parameter for quality control of the printing paper based on a result of the measurement by the sensor, a display apparatus adapted to display the printing evaluation information calculated by the printing evaluation information calculation section, and a printing press operation information acquisition section adapted to acquire one or more kinds of operation information of the printing press, the display apparatus displaying the printing press operation information acquired by the printing press operation information acquisition section together with the printing evaluation information. It is to be noted that, as the sensor described above, any sensor for detecting information regarding the quality of printing paper may be used, and, as a representative sensor, for example, a reflection light sensor for measuring reflection light from printing paper is available. Further, it is a possible idea to configure the display apparatus such that the printing evaluation information and the printing press operation information are displayed in parallel to each other.

Preferably, the printing evaluation information includes at least one of dot gain information, trapping information, solid density information and contrast information (claim 2). Preferably, the printing press operation information includes at least one of ink supplying amount information, dampening water supplying amount information and printing speed information (claim 3).

Consequently, the printing operator can carry out printing quality management with high accuracy by grasping the printing evaluation information and the printing press driving information.

Preferably, the display apparatus displays time-dependent change of the printing evaluation information and the printing press operation information as parallel graphs on the same time base (claim 4).

Consequently, the printing operator can easily grasp with which factor of the printing press operation information is associated with the variation of the printing evaluation information and can carry out the printing quality management with high accuracy.

Preferably, the display apparatus displays an average value of each of the printing evaluation information and the printing press operation information during predetermined time (claim 5).

Consequently, the value at some point of time and the average value during predetermined time of each of the printing evaluation information and the printing press operation information can be grasped at the same time and the printing quality management can be performed with high accuracy.

It is to be noted that the predetermined time for calculation of an average value may be suitably set by inputting from inputting means such as an operation panel.

Preferably, the display apparatus displays a preferable range of each kind of information together with values of the printing evaluation information and the printing press operation information (claim 6). Consequently, the printing operator can easily grasp the preferable range of each kind of the information.

Preferably, the sensor is an IRGB densitometer (claim 7). Consequently, the color tone of a printed matter including black plate printing can be read with high accuracy.

According to the invention as set forth in claim 8, there is provided a printing evaluation information displaying method for a printing press, comprising a step of measuring printing paper printed by the printing press by means of a sensor, a step of calculating one or more kinds of printing evaluation information each to be used as a parameter for quality control of the printing paper based on a result of the measurement by the sensor, a step of displaying the calculated printing evaluation information, and a printing press operation information acquisition step of acquiring one or more kinds of operation information of the printing press, the printing press operation information acquired at the printing press operation information acquisition step being displayed together with the printing evaluation information.

### Effects of the Invention

With the printing evaluation information displaying apparatus and printing evaluation information displaying method for a printing press of the present invention, the printing operator can grasp the printing evaluation information and the printing press operation information at the same time. Consequently, since, for example, the printing operator can easily grasp what kind of printing press operation information makes a factor in a case wherein the printing evaluation information is not within the preferable range, the printing operator can adjust a suitable portion of the printing press so that quality management of printing paper is carried out at a high speed and with high accuracy.

Further, since the printing operator can grasp the printing press operation information when the various kinds of printing evaluation information are within the preferable range (optimum range), optimum operation adjustment can be carried out in accordance with a characteristic of the printing press.

### BRIEF DESCRIPTION OF THE DRAWINGS

FIG. 1 is a block diagram illustrating a printing evaluation information displaying apparatus for a printing press according to an embodiment of the present invention and showing a configuration of essential part of the printing evaluation information displaying apparatus.

FIG. 2 is a view illustrating the printing evaluation information displaying apparatus for a printing press according to the embodiment of the present invention and schematically showing a general configuration of a printing press.

FIG. 3 is a perspective view illustrating the printing evaluation information displaying apparatus for a printing press according to the embodiment of the present invention and schematically showing an arrangement configuration of a reflection light sensor.

FIG. 4 is a view illustrating the printing evaluation information displaying apparatus for a printing press according to the embodiment of the present invention and schematically showing a configuration of a printing unit.

FIG. 5 is a graph illustrating the printing evaluation information displaying apparatus for a printing press according to the embodiment of the present invention and showing an example of the display mode of the displaying apparatus wherein the axis of abscissa indicates the time base and the axis of ordinate indicates the value of various kinds of information.

FIG. 6 is a graph illustrating the printing evaluation information displaying apparatus for a printing press according to the embodiment of the present invention and showing another example of the display mode of the displaying apparatus wherein the axis of abscissa indicates the time base and the axis of ordinate indicates the value of various kinds of information.

### DESCRIPTION OF REFERENCE CHARACTERS

1 printing web (printing paper)
1A printing picture
1B color patch
2 in-feed apparatus
3 printing unit
3A upper unit
3B lower unit
4 IRGB densitometer (sensor)
10 printing drum
11 ink supplying apparatus
12 dampening water supplying apparatus
13 blanket drum
14 ink key
15 ink source roller
16 inker
17 water boat
18 dampening water source roller
19 dampening water roller
20 printing press controlling apparatus
21 monitor controlling apparatus
22 monitor (display apparatus)
23 operation panel
31 printing evaluation information calculation section (printing evaluation information calculation means)
32 printing press operation information acquisition section (printing press operation information acquisition means)
33 monitor controlling section
50 paper feeding section
51 printing section
52 drier section
53 cooling section
54 web pass section
55 folding processing section
100 printing press

### BEST MODE FOR CARRYING OUT THE INVENTION

In the following, an embodiment of the present invention is described with reference to the drawings.

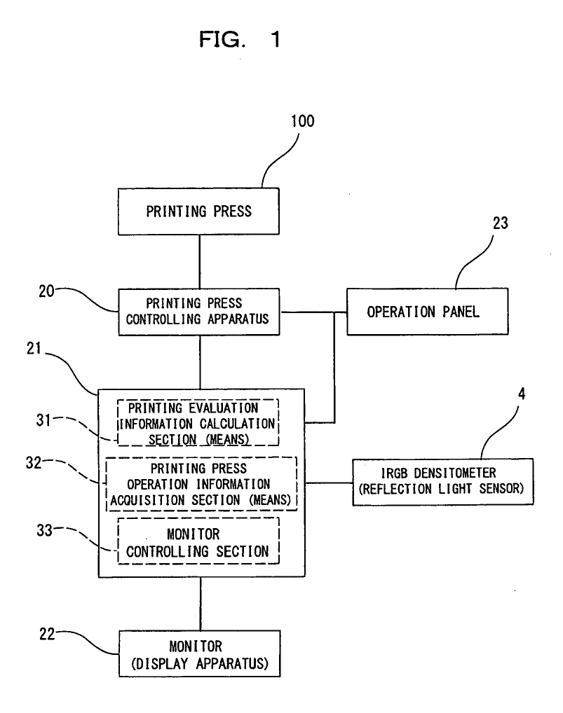

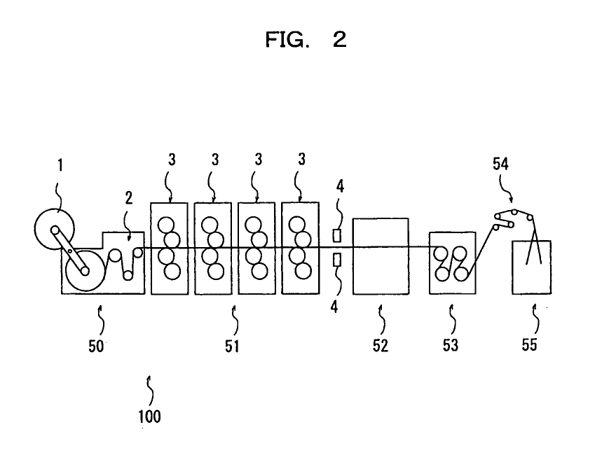

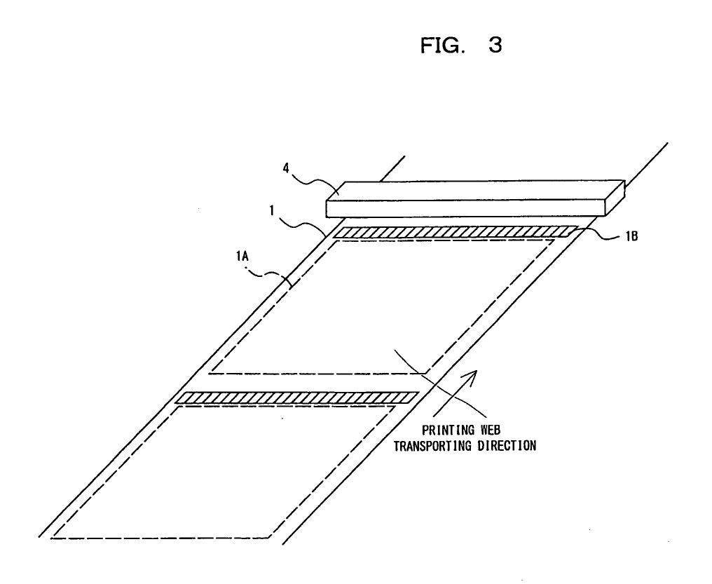

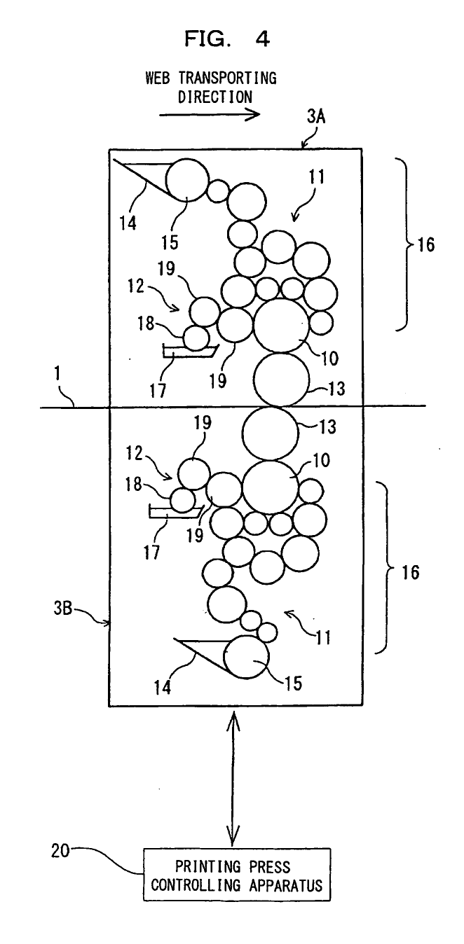

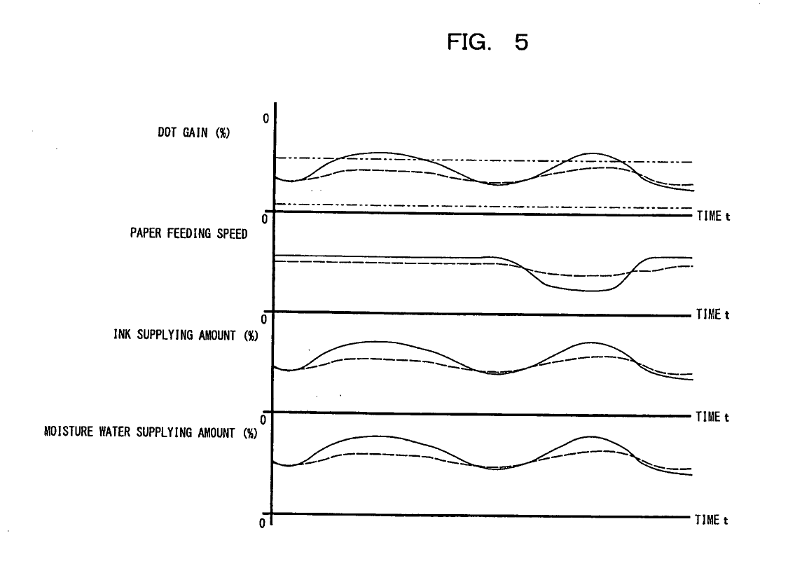

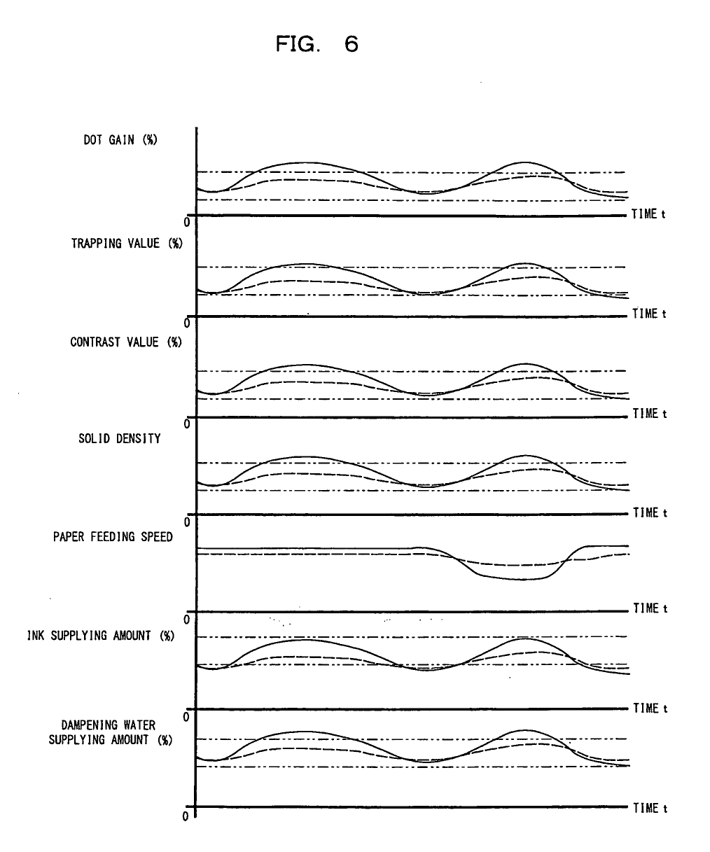

FIGS. 1 to 6 are views illustrating a printing evaluation information displaying apparatus and a printing evaluation information displaying method for a printing press according to an embodiment of the present invention. FIG. 1 is a block diagram showing a configuration of essential part of the printing evaluation information displaying apparatus; FIG. 2 is a view schematically showing a general configuration of the printing press; FIG. 3 is a perspective view schematically showing an arrangement configuration of a reflection light sensor of the printing press; FIG. 4 is a view schematically showing a configuration of a printing unit of the printing press; and FIGS. 5 and 6 are graphs individually showing different examples of a displaying mode of the printing evaluation information displaying apparatus wherein the axis of abscissa indicates the time base and the axis of ordinate indicates the value of various kinds of information.

In the present embodiment, the printing evaluation information displaying apparatus of the present invention is applied to an offset rotary printing press (hereinafter referred to simply as printing press) which carries out, as a printing press, four-color printing for both faces of a printing web (printing paper) 1 which is continuous paper. It is to be noted that not only the printing press in the present embodiment but also a sheet-fed press for carrying out printing on paper sheets may be applied as the printing press, and also the number of printing colors can be suitably changed.

### (General Configuration of the Printing Press)

An offset rotary printing press (hereinafter referred to simply as printing press) 100 to which the printing evaluation information displaying apparatus of the present invention is applied as shown in FIG. 2 includes a paper feeding station 50, a printing station 51, a drier station 52, a cooling station 53, a web pass station 54 and a folding processing station 55 in order from the upstream side. The paper feeding station 50 delivers the roll-formed printing web 1 mounted on a roll stand by means of an in-feed apparatus 2 such that printing is carried out on the printing web by the printing station 51.

The printing station 51 includes four printing units 3 corresponding to ink colors of process colors of C (cyan), M (magenta), Y (yellow) and K (black).

Then, the web 1 printed in the printing station 51 is transported through the drier station 52, cooling station 53 and web pass station 54 to the folding processing station 55, in which a folded document is produced.

A line sensor type IRGB densitometer (reflection light sensor as a sensor for detecting information regarding the quality of printing paper) 4 is provided on both face sides of the printing web 1 between the printing station 51 and the drier station 52.

The IRGB densitometer 4 is a measuring instrument for measuring reflection light of ink transferred to the printing web 1 as reflection densities of I (infrared light), R (red), G (green) and B (blue). As shown in FIG. 3, the IRGB densitometer 4 is disposed for measurement of the reflection densities along the overall width in a widthwise direction of the printing web 1. Then, a result of measurement by the IRGB densitometer 4 is inputted to a monitor controlling apparatus 21 (refer to FIG. 1).

A measurement region of the reflection light by the IRGB densitometer 4 is configured for setting to an arbitrary region on the printing web 1. The measurement region may be set so that the reflection densities of the colors of I, R, G and B in a predetermined region of a printing picture 1A transported after successive transfer to the printing web 1 by the printing station 51 are measured, and, for example, the measurement region may be set so that the reflection densities of the colors of I, R, G and B of a color patch 1B printed at a margin portion of the printing picture 1A are measured.

It is to be noted that, while only the front face side of the printing web 1 is shown in FIG. 3, a similar IRGB densitometer 4 is provided also on the reverse face side.

Now, a configuration of each printing unit 3 is described. As shown in FIG. 4, the printing unit 3 includes an upper unit 3A for carrying out printing on the upper face (front face) of the web 1 and a lower unit 3B for carrying out printing on the lower face (reverse face) of the web 1.

Since the upper and lower units 3A and 3B are configured substantially similarly to each other except that they are configured in a vertically opposite relationship with each other, the upper unit 3A is described here.

The upper unit 3A includes a printing drum 10 on which a printing plate (not shown) on which a picture to be printed is formed is to be mounted, an ink supplying apparatus 11 for supplying ink to the plate mounted on the printing drum 10, a dampening apparatus 12 for supplying dampening water to the plate mounted on the printing drum. 10, and a blanket drum 13 which is a transfer drum for transferring the image (printing picture 1A and color patch 1B) of the plate mounted on the printing drum 10 to the printing web 1.

The ink supplying apparatus 11 is configured from an ink key 14, an ink source roller 15 and an inker 16.

A plurality of such ink keys 14 are juxtaposed with each other in the widthwise direction of the printing web 1 over the overall width of the printing web 1, and the ink keys 14 are opposed to the ink source roller 15. Then, an ink pot which is a supplying source of ink is formed from the ink source roller 15 and the plural ink keys 14, and the gap between the ink keys 14 and the ink source roller 15 (the gap is referred to ink key opening) and the speed of rotation of the ink source roller 15 are adjusted so that the amount of ink to be supplied to each ink supplying width corresponding to each ink key 14 is adjusted.

The ink supplied from the gap between the ink keys 14 and the ink source roller 15 is transported by successive transfer of the ink in the inker 16 including a group of a plurality of ink rollers and is supplied to the printing drum 10. The ink supplied to the printing drum 10 is transferred to the printing web 1 through the blanket drum 13 so that the printing picture 1A and the color patch 1B are formed. It is to be noted that the gap amount of each blanket drum 13 is set such that a predetermined pressure (printing pressure) is applied to the printing web 1 when the ink is transferred to the printing web 1 passing between the blanket drum 13 of the upper unit 3A and the blanket drum 13 of the lower unit 3B. In particular, the blanket drums 13 here individually have a function also as a pressure drum.

The dampening apparatus 12 is configured from a water boat 17, a dampening water source roller 18 and a plurality of dampening water rollers 19 and supplies dampening water from the water boat 17 in which dampening water is reserved to the printing drum 11 through the dampening water source roller 18 and the plural dampening water rollers. The supplying amount of the dampening water is adjusted based on the speed of rotation of the dampening water source roller 18.

It is to be noted that the operation mode of the ink keys 14, ink source roller 15 and dampening water source roller 18 of each printing unit 3 is controlled by a printing press controlling apparatus 20.

### (Configuration of Essential Part of the Display Apparatus)

Here, a configuration of essential part of the printing evaluation information displaying apparatus is described.

As shown in FIG. 1, the controlling system of the printing evaluation information displaying apparatus is configured from the printing press controlling apparatus 20 and the monitor controlling apparatus 21 which are configured from a computer or the like, and the printing press controlling apparatus 20 and the monitor controlling apparatus 21 are electrically connected to each other.

The printing press controlling apparatus 20 is electrically connected to various apparatus of the printing press 100 including the ink supplying apparatus 11, dampening water supplying apparatus 12 and so forth of the printing units 3, and transmits a controlling signal to the individual apparatus to control the operation states (that is, the ink supplying amount, dampening water supplying amount, printing speed and so forth) of the apparatus.

Further, the printing press controlling apparatus 20 is electrically connected to an operation panel 23, and the printing operator can adjust the operation states of the apparatus described above of the printing 100 by inputting through the operation panel 23.

The monitor controlling apparatus 21 is connected to the IRGB densitometer 4, and a result of measurement of the printing web 1 is successively inputted from the IRGB densitometer 4 to the monitor controlling apparatus 21 as described above. Further, the monitor controlling apparatus 21 is connected also to the operation panel 23, and an input signal from the operation panel 23 is inputted to the monitor controlling apparatus 21.

On the other hand, the monitor controlling apparatus 21 is connected to a monitor (display apparatus) 22, and an image is displayed on the monitor 22 based on an input signal from the monitor controlling apparatus 21. Further, the monitor 22 has a warning sound generation apparatus such as a speaker built therein.

It is to be noted that, while the printing press controlling apparatus 20 and the monitor controlling apparatus 21 here are configured separately from each other, they may otherwise be configured as separate functional elements of a unitary computer. Further, while the monitor 22 and the operation 23 here are configured separately from each other, the monitor 22 may be configured as a touch panel so as to have also the function as the operation panel 23. Further, while the warning sound generation apparatus here is built in the monitor 22, the warning sound generation apparatus may be provided separately from the monitor 22.

The monitor controlling apparatus 21 includes a printing evaluation information calculation section (printing evaluation information calculation means) 31, a printing press operation information acquisition section (printing press operation information acquisition means) 32 and a monitor controlling section 33 as functional elements thereof.

The printing evaluation information calculation section 31 calculates a dot gain value (dot gain information), a trapping value (trapping information), a contrast value (contrast information) and a solid density value (solid density information) as printing evaluation information from a result of measurement of reflection densities of the colors of I, R, G and B inputted from the IRGB densitometer 4.

The various kinds of the printing evaluation information are described particularly.

The solid density value is a density value in a solid state (printing area ratio is 100%). The density value can be calculated from a result of measurement of reflection densities of the colors of I, R, G and B.

Further, where the dot gain value, trapping value and contrast value are to be calculated from the density value, the values are calculated based on such expressions as given below.

Where the density of a screen tint is represented by Dt, the solid density by Ds and the film dot which is a dot on a printing plate by Fd, the dot gain value DG (%) can be calculated based on the following expression (1):

DG(%)=[(1−10−Dt)/(1−10−Ds)]×100−Fd(%) (1)

Where the first color density is represented by D1, the second color density by D2 and the color mixture (overprint) density by D3, the trapping value T (%) can be calculated based on the following expression (2):

T(%)=[(D3−D1)/D2]×100 (2)

Where the 75% density is represented by D75, the contrast value C (%) can be calculated based on the following expression (3):

C(%)=[(Dt−D75)/Dt]×100 (3)

The solid density and such a screen tint density as 75%, 50%, 25% or the like are used as the density value, and the L*a*b* colorimetric system (CIELAB) is used as the color measurement value.

Such printing evaluation information can be calculated regarding an arbitrary position in the widthwise direction of the printing web 1, or also it is possible to calculate an average value regarding an arbitrary region in the widthwise direction of the printing web 1.

The printing press operation information acquisition section 32 acquires and stores various kinds of printing press operation information, which are operation information of the individual apparatus of the printing press 100, for being displayed on the monitor 22 based on inputting from the printing press controlling apparatus 20. It is to be noted that the printing press operation information acquired by the printing press operation information acquisition section 32 includes the operation speed (paper feeding speed) of the printing press 100, the ink supplying amount for each ink supplying width (ink key opening and speed of rotation of the ink source roller 15) and the dampening water supplying amount (speed of rotation of the dampening water source roller 18). Further, it is preferable for the printing press operation information to include also the printing pressure and the material of the blanket drum 13 which are portions to be adjusted when the dot gain value is to be corrected by a coping method which may be applied where the dot gain value or the contrast value deviates from a suitable range. Further, it is preferable for the printing operation information to include also the viscosity of used ink to be adjusted when the trapping value deviates from a suitable range.

It is to be noted that it is preferable for printing operation information to include also information of the paper material, temperature, humidity and so forth. This is because, by this, adjustment of the dampening water supplying amount, adjustment of the ink supplying amount, adjustment of the printing pressure, change of the material of the blanket drum, change of the viscosity of the used ink and so forth taking the paper material, temperature, humidity and so forth into consideration can be carried out.

The monitor controlling section 33 is configured so as to control the display contents on the monitor 22 and displays the values of the various kinds of printing evaluation information calculated by the printing evaluation information calculation section 31 and the values of the various kinds of printing press operation information acquired by the printing press information acquisition section 32 on the monitor 22.

It is to be noted that the monitor controlling section 33 can calculate average values per predetermined time individually regarding the various kinds of printing evaluation information calculated by the printing evaluation information calculation section 31 and the printing press operation information acquired by the printing press operation information acquisition section 32 so that an average value per predetermined time can be displayed on the monitor 22 together with the values at the point of time of the calculation just described. The setting of the predetermined time at this time can be carried out by inputting through the operation panel 23.

Further, a suitable range of the printing evaluation information calculated in advance by an experiment or the like in order to obtain printing paper having good quality is inputted to and stored in the monitor controlling apparatus 21 for each of the various kinds of printing evaluation information, and the monitor controlling section 33 displays the suitable range on the monitor 22 together with the calculated values of the printing evaluation information and the average value of the calculated values.

Here, the suitable range of the printing evaluation information is a range of the dot gain value, trapping value or contrast value having a margin within which no loss paper is produced from a suitable dot gain value, a suitable trapping value or a suitable contrast value when a printing matter having a predetermined printing area ratio is printed.

Further, the monitor controlling section 33 displays a warning on the monitor 22 and generates alarm sound from the speaker built in the monitor 22 where some value of the printing evaluation information deviates from the suitable range.

Further, the monitor controlling apparatus 21 stores in advance therein affair information considered as an effective coping method where some of the various kinds of printing evaluation information (dot gain value, trapping value, contrast value or solid density value) deviates from the suitable range, and displays various coping methods for returning the printing evaluation information deviated from the suitable range to the suitable range and a priority order of the various coping methods on the monitor 22.

A corresponding relationship between the various kinds of printing evaluation information and the coping methods is described below. It is to be noted that the coping methods and the priority order described below are an example, and they are not limited to the example described below but can be suitably set.

The coping methods and the priority degree of them which seem available in a case wherein the dot value deviates from the suitable range are such as given below.
1: Adjustment of the dampening water supplying amount
2: Adjustment of the ink supplying amount
3: Adjustment of the printing pressure
4: Changing of the material of the blanket drum 13

Further, the coping methods and the priority degree of them which seem available in a case wherein the trapping gain value deviates from the suitable range are such as given below.
1: Adjustment of the ink supplying amount
2: Adjustment of the dampening water supplying amount
3: Adjustment of the printing pressure
4: Change of the viscosity of the used ink

Further, the coping methods and the priority degree of them which seem available in a case wherein the contrast value deviates from the suitable range are such as given below.
1: Adjustment of the ink supplying amount
2: Adjustment of the dampening water supplying amount
3: Adjustment of the printing pressure
4: Change of the material of the blanket drum 13

The displaying mode of the monitor 22 by the monitor controlling section 33 is described below. FIGS. 5 and 6 show each an example of a displaying mode of the monitor 22 and are graphs wherein the axis of abscissa indicates the time t and the axis of ordinate indicates the value of various kinds of information.

As shown in FIG. 5, the dot gain value as the printing evaluation information and the values of the ink supplying amount, dampening water supplying amount and paper feeding speed as the printing press operation information are displayed in parallel on the same time axis on the monitor 22. In particular, the printing evaluation information and the printing press operation information can be visually confirmed at the same time.

The display just described is carried out on the real-time basis based on the reflection density successively measured by the IRGB densitometer 4.

Or, the monitor 22 may be configured otherwise such that various kinds of information at any time in the past can be displayed in accordance with inputting through the operation panel 23.

Further, also the displaying range of the time axis t (length of the time axis) is configured for suitable setting in accordance with an input through the operation panel 23. For example, all of time-dependent changes (histories) of the values may be displayed in a unit of one day, or time-dependent changes a noticed time zone or in several minutes in the latest time zone may be displayed.

It is to be noted that other kinds of printing evaluation information (trapping value, contrast value, solid density value) can be also displayed as the printing evaluation information in place of the dot gain value.

Further, as the printing evaluation information, all of the trapping value, contrast value and solid density value can be also displayed at the same time together with the dot gain value as shown in FIG. 6. Changeover of the display of the printing evaluation information can be suitably carried out by the printing operator by inputting through the operation panel 23.

Here, the displaying mode in FIG. 5 is described more particularly. Regarding each of the kinds of information such as the dot gain information, ink supplying amount information, dampening water supplying information, and paper feeding speed information, a time-dependent change line (indicated by a solid line in the figure) which indicates a time-dependent change of the values at time t and an average value line (indicated by a broken line in the figure) which indicates an average value of the values of the information at the set predetermined time are displayed in parallel on the same time axis t.

In addition, regarding the dot gain information as the printing evaluation information, the suitable range (indicated by a long and two short dashes line in the figure) of the dot gain value (time-dependent change line) is displayed.

It is to be noted that the various kinds of printing evaluation information can be displayed in a state wherein an arbitrary position in the widthwise direction of the printing web 1 is targeted, and the position in the widthwise direction (widthwise direction coordinate range) of the printing web 1 to be targeted as the printing evaluation information can be designated by inputting through the operation panel 23.

Since the line sensor and the printing press including the line sensor according to the embodiment of the present invention are configured in such a manner as described above, when printing is carried out, the printing operator can grasp not only the dot gain information, trapping information, contrast information and solid density information as the printing evaluation information but also various kinds of information such as the ink supplying amount, dampening water supplying amount and paper feeding speed as the printing press operation information through the display on the monitor 22 at the same time. The various kinds of information can be displayed at the arbitrary position in the widthwise direction of the printing web 1 by operation through the operation panel 23.

Further, since the average values per predetermined time of the values of the various kinds of printing evaluation information are displayed at the same time, the printing operator can grasp a difference between the values of the information and the average value at the point of time and the difference can be used for reference of printing quality adjustment working.

Further, since the suitable range of the values of the printing evaluation information and the printing press operation information is displayed and, where the printing evaluation information is not within the suitable range, a warning screen image is displayed and alarm sound is generated, the printing operator can be notified that the printing evaluation information deviates from the suitable range. Further, since the printing operator can easily grasp what kind of information from within the printing press operation information causes the deviation, the printing operator can operate the operation panel 23 to adjust a suitable apparatus portion of the printing press 100 so that quality management of printing paper can be carried out quickly with high accuracy.

Here, a modification to the present embodiment is described. In the present modification, the displaying mode of the monitor 22 by the monitor controlling section 33 is different from that in the embodiment described above.

In the present modification, the monitor controlling section 33 is configured such that, where some of the printing evaluation information (dot gain value, trapping value, contrast value, solid density value or the like) deviates from the suitable range, the various kinds of printing press information whose priority order is ranked in the highest position from among the various kinds of the printing press information deviating from the suitable range are displayed based on the priority order of the printing press operation information to be adjusted more preferentially from among the various kinds of printing press operation information in addition to the display in the embodiment described above.

For example, the degree of priority (priority order) where the dot gain value deviates from the suitable range in the embodiment described above is set similarly as in the embodiment described above.
1: Adjustment of the dampening water supplying amount
2: Adjustment of the ink supplying amount
3: Adjustment of the printing pressure
4: Change of the material of the blanket drum 13
   At this time, if the dampening water supplying amount deviates from an optimum value (suitable range) with respect to the printing area ratio of the printed matter, then display (notification) that the dampening water supplying amount is to be adjusted is carried out.

On the other hand, if the dampening water supplying amount has the optimum value with respect to the printing area ratio of the printed matter, the ink supplying amount is checked next. Then, if the ink supplying amount deviates from the optimum value (suitable range) with respect to the printing area ratio of the printed matter, then the display that the ink supplying amount is to be adjusted is carried out.

On the other hand, if the ink supplying amount has the optimum value (suitable range) with respect to the printing area ratio of the printed matter, the printing pressure is checked next. Then, if the printing pressure deviates from the optimum value (suitable range) with respect to the printing area ratio of the printed matter, then the display that the printing pressure is to be adjusted is carried out. On the other hand, if the printing pressure has the optimum value with respect to the printing area ratio of the printed matter, then the display that the material of the blanket drum 13 is to be changed is carried out.

With such a configuration as described above, the printing operator can visually confirm easily what printing press operation information is to be adjusted.

It is to be noted that, in place of the display through the monitor 22 described above, the printing press controlling apparatus 20 may automatically carry out adjustment of the dampening water supplying amount, ink supplying amount and printing pressure.

### Others

While the embodiment of the present invention is described above, the present invention is not limited to the embodiment specifically described above, and variations and modifications can be made without departing from the scope of the present invention.

For example, while, in the embodiment, an IRGB densitometer as a sensor is disposed on a transport line for printing paper of a printing press so that a reflection density of the printing paper is displayed online, such a reflection light sensor as described above need not be limited as the sensor to be applied but a sensor capable of detecting information regarding quality of paper may be applied. Also the disposition place of the sensor is not limited to the transport line for the printing paper as in the embodiment described above. Particularly, in a sheet-fed printing press or the like, where measurement of reflection light of printing paper is carried out, the printing paper may be extracted from the printing press to carry out measurement of reflection light using a reflection light sensor prepared separately from the printing press.

Further, while, in the embodiment described above, the printing evaluation information and the printing press operation information are displayed in the form of a graph, the form of the display is not limited to the graph but can be suitably changed. For example, the values of the printing evaluation information and the printing press operation information may be displayed as numerical value data in parallel to each other on the real-time basis. However, the display mode of the printing evaluation information and the printing press operation information is not limited to the parallel display.

### INDUSTRIAL APPLICABILITY

Where the present invention is used for operation manipulation of a printing press, the operability by the printing operator is improved, and the present invention can be applied widely to the printing technique.

What is claimed is:

1. A printing evaluation information displaying apparatus for a printing press, comprising:
a sensor for measuring printing paper printed by said printing press;
a printing evaluation information calculation section adapted to calculate one or more kinds of printing evaluation information each to be used as a parameter for quality control of the printing paper based on a result of the measurement by said sensor;
a display apparatus adapted to display the printing evaluation information calculated by said printing evaluation information calculation section; and
a printing press operation information acquisition section adapted to acquire one or more kinds of operation information of said printing press;
said display apparatus displaying the printing press operation information acquired by said printing press operation information acquisition section together with the printing evaluation information.

2. The printing evaluation information displaying apparatus for a printing press as claimed in claim 1, wherein the printing evaluation information includes at least one of dot gain information, trapping information, solid density information and contrast information.

3. The printing evaluation information displaying apparatus for a printing press as claimed in claim 1 or 2, wherein the printing press operation information includes at least one of ink supplying amount information, dampening water supplying amount information and printing speed information.

4. The printing evaluation information displaying apparatus for a printing press as claimed in any one of claims 1 to 3, wherein said display apparatus displays time-dependent change of the printing evaluation information and the printing press operation information as parallel graphs on the same time base.

5. The printing evaluation information displaying apparatus for a printing press as claimed in any one of claims 1 to 4, wherein said display apparatus displays an average value of each of the printing evaluation information and the printing press operation information during predetermined time.

6. The printing evaluation information displaying apparatus for a printing press as claimed in any one of claims 1 to 5, wherein said display apparatus displays a preferable range of each kind of information together with values of the printing evaluation information and the printing press operation information.

7. The printing evaluation information displaying apparatus for a printing press as claimed in any one of claims 1 to 6, wherein said sensor is an IRGB densitometer.

8. A printing evaluation information displaying method for a printing press, comprising:
a step of measuring printing paper printed by said printing press by means of a sensor;
a step of calculating one or more kinds of printing evaluation information each to be used as a parameter for quality control of the printing paper based on a result of the measurement by the sensor;
a step of displaying the calculated printing evaluation information; and
a printing press operation information acquisition step of acquiring one or more kinds of operation information of the printing press;
the printing press operation information acquired at the printing press operation information acquisition step being displayed together with the printing evaluation information.
